(19) United States
(12) Patent Application Publication
(10) Pub. No.: US 2026/0133016 A1
(43) Pub. Date: May 14, 2026

(54) SYSTEMS AND METHODS FOR AUTOMATED TARGET IDENTIFICATION, CLASSIFICATION, AND SCORING

(71) Applicant: ACCUSHOOT, INC., Corvallis, OR (US)

(72) Inventor: Francisco Martin, Corvallis, OR (US)

(21) Appl. No.: 19/111,292

(22) PCT Filed: Sep. 13, 2023
(86) PCT No.: PCT/US2023/032668

§ 371 Date: Mar. 12, 2025

Related U.S. Application Data
(60) Provisional application No. 63/406,208, filed on Sep. 13, 2022.

(51) Int. Cl. F41J 5/10; F41J 5/14; G06V 10/25; G06V 10/74; G06V 10/764

(52) U.S. Cl. CPC F41J 5/10; G06V 10/25; G06V 10/761; G06V 10/764; F41J 5/14; G06V 2201/07

(57) ABSTRACT

A system is configured to receive images of a target located down range, identify the target in the images and classify the target to determine the location of the scoring regions. The system is further configured to determine the likelihood of an actual impact from a projectile on the target and score an actual projectile impact. The system uses machine vision and a machine learning model to classify the targets and determine impact scores.

### CROSS-REFERENCE TO RELATED APPLICATIONS

This application claims the benefit of U.S. Provisional Ser. No. 63/406,208, filed Sep. 13, 2022, entitled “SYSTEMS AND METHODS FOR AUTOMATED TARGET IDENTIFICATION, CLASSIFICATION, AND SCORING,” the contents of which is incorporated herein by reference in its entirety.

### BACKGROUND

Target shooting is enjoyed by millions of people a year and according to many reports, the number of people who routinely target shoot has increased over the past ten years and is continuing to increase. In the US alone, it is estimated that over 52 million people routinely shoot at targets. There are many different types of recreational shooting activities, from simple plinking with handguns or rifles at paper or steel targets, to skilled long-range rifle shooting matches that require a high degree of discipline and skill, to fun and fast-paced shooting of pistols at popup or stationary targets or shotgun shooting at skeet, trap, sporting clays and more. Apart from recreational shooting, there is a growing number of target shooters that practice as part of their occupation, such as law enforcement, military, and security personnel.

The growing number of people at shooting ranges continues to increase and these participants, whether there for sport, recreation, personal defense, or public defense, have a desire to improve their skills. However, at a busy shooting range that allows paper targets, it can be disrupting to require the range to go cold in order to move downrange to set up, inspect, score, or replace the targets. Similarly, at any of a number of shooting competitions, the range must go cold before competitors are allowed to move downrange to inspect, score, and replace their targets.

The effort required to score and replace targets can be disruptive to other shooters at the range, and in some cases, requires participants to walk 100 yards, 300 yards, 600 yards, 1000 yards or more in order to inspect, score, and replace a target. This is very time consuming, especially where only a single shooter at a busy range desires to make the range safe in order to replace a target, while the remaining shooters must cease firing, make their weapons safe, and wait while one person proceeds down range.

Scoring a target is a relatively simple process as many targets include scoring rings. A participant can visually inspect a target and see where the projectile penetrated the target and assign a score based on the number of penetrations and the score of each penetration. However, where a steel target is utilized, these shots are very difficult, if not impossible, to score since shooting at a steel target is a largely binary effect, either a satisfying ping when a projectile hits its mark, or silence where a shooter misses. It is very difficult to determine the location on a steel target that is hit since most steel targets are not replaced and even if a dent or a hole is made in the steel target, it is very difficult to ascertain a new dent from preexisting dents.

It would be advantageous if a system were capable of automatically scoring a shooting target, whether a replaceable paper target or a more permanent target, such as a steel target. This would provide increased efficiency in practice or competition, among other things. These and other benefits will become readily apparent from the disclosure that follows.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for automatically scoring a shooting target. The method also includes receiving one or more images of a target; generating a bounding box around the target, classifying the target, determining scoring rings of the target, receiving one or more additional images of the target, determining a difference between a short-term moving average and a long-term moving average based on received images of the target, filtering the difference between the short-term moving average and the long-term moving average to determine an impact, and executing an impact classifier that receives the difference and outputs a score of the impact. Other embodiments of this aspect include corresponding computer systems, apparatus, and computer programs recorded on one or more computer storage devices, each configured to perform the actions of the methods.

Implementations may include one or more of the following features. The method where the receiving the one or more images is performed by a video capture device associated with a mobile computing device. The method may be performed on a smart phone. Determining a difference between a short-term moving average and a long-term moving average may include convolving a difference image with an impact kernel. The impact kernel may be a 5×5, uniform weight, square kernel. The impact classifier may be configured to replace a window around a potential impact in the long-term moving average image with the short-term moving average that includes the potential impact. The method may include replacing the window around the potential impact in the long-term moving average image with the short-term moving average that includes the potential impact for at least 5 subsequent frames. The window may be at least a 10×10 pixel window. Generating a bounding box around the target may include iteratively modifying one or more corners of the bounding box to generate a modified bounding box and projecting the modified bounding box onto a reference target image. The method may include determining corners of the modified bounding box by a hill-climbing technique. The method may include determining coordinates of the impact and determining that the coordinates of the impact are within a scoring ring. Implementations of the described techniques may include hardware, a method or process, or computer software on a computer-accessible medium.

One general aspect includes a system for automatically scoring a target including a computing device having one or more processors, the one or more processors configured with instructions, the instructions may include: an image analyzing module configured to receive one or more images from an imaging sensor associated with the computing device; a target classifier configured to determine one or more boundaries of the target and determine geometric boundaries of one or more scoring regions; an impact kernel configured to compare two or more images and determine a possible impact; a machine learning model configured to receive data associated with the possible impact and determine a likelihood of an actual impact; and a scoring module configured to determine a score of the impact where the likelihood of an actual impact exceeds a threshold value. Other embodiments of this aspect include corresponding computer systems, apparatus, and computer programs recorded on one or more computer storage devices, each configured to perform the actions of the methods.

Implementations may include one or more of the following features. The system where the computing device is a smart phone. The target classifier may be configured to apply object detection to the one or more images and determine corners of the target. Implementations of the described techniques may include hardware, a method or process, or computer software on a computer-accessible medium.

### BRIEF DESCRIPTION OF THE DRAWINGS

The accompanying drawings are part of the disclosure and are incorporated into the present specification. The drawings illustrate examples of embodiments of the disclosure and, in conjunction with the description and claims, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

FIG. 1 illustrates a system configured for automatic scoring of a shooting target, in accordance with some embodiments;

FIG. 2 illustrates a sample process flow for classifying and scoring a target, in accordance with some embodiments;

FIG. 3 illustrates a sample process flow for identifying and classifying a target, in accordance with some embodiments;

FIG. 4 illustrates a sample process flow for registering a target and determining scoring hits, in accordance with some embodiments;

FIGS. 5A, 5B, and 5C illustrate a method for initializing a target scoring system to identify a target, in accordance with some embodiments;

FIG. 6 illustrates a sample process flow for detecting impacts on a target, in accordance with some embodiments;

FIG. 7 illustrates a sample process flow for scoring impacts on a target, in accordance with some embodiments; and

FIG. 8 illustrates a sample user interface for automated target scoring in a software application, in accordance with some embodiments.

### DETAILED DESCRIPTION

According to some embodiments, a system is described that can quickly identify a target, classify a target including identifying scoring rings of the target, and score impact hits on a target at a shooting range. In some cases, the system is stored and executed on consumer-grade mobile computing devices (e.g. an iPhone, a tablet, a telephone, a video camera). In some cases, the system includes a video camera device that is pointed at the target of interest, and the system is configured to identify the target, classify the target, determine shot impacts on the target, and score the impacts on the target. In some cases, the system is configured to prompt a shooter as to the shooting stage. For instance, the system may be configured for utilization during a CMP high-power rifle competition, and the system may prompt a user that the present stage requires sending twenty shots downrange from an off-hand position during a 20-minute window. In some cases, the system is aware of how many shots to expect during a shooting stage (referred to as a string of fire), and may prompt a user with information associated with a current shooting stage, such as number of shots, timeframe, and shooting position. In some cases, a shooter may enter information associated with a shooting stage, such as, for example, a number of shots the system should expect, the firearm used, and the distance to the target, among others. In some cases, the system is manually started and stopped and only identifies shots on target during a time at which the system has been started.

In some cases, the described system operates in near real-time on a single, consumer recording device such as a mobile phone using only a modest amount of training data. As used herein, the terms “real-time” or “near real time” are broad terms and in the context of this disclosure, relate to receiving input data, processing the input data, and outputting the results of the data analysis with little to no perceived latency by a human. In other words, a system as described herein that outputs analyzed data within less than one second is considered near-real time. A system that operates in real-time or near-real time may limit the amount of computation for machine-learning, or at least training models, that the method can use to characterize a particular target acquisition, classification, and scoring.

Prior approaches to automated target scoring have relied upon sound triangulation, light triangulation, and piezoelectric sensors triangulation. Sound triangulation has been attempted by using sound-chamber targets, which use the Mach wave of the projectile to determine its position as it passes through the target. A sound triangulation automated scoring system operates by using microphones to measure the sound wave of the projectile as it passes through the target. The sound of the projectile passing through the target can then be used from a multitude of audio sensors (e.g., microphones) to determine the location that the projectile passed through the target.

A light triangulation automated scoring system uses three or more lasers, such as infrared lasers. The three or more lasers are used to triangulate the position of the projectile as it passes through the target. A piezoelectric sensor triangulation system relies on a series of piezoelectric sensors on a plate that sense vibrations caused by projectiles impacting a target.

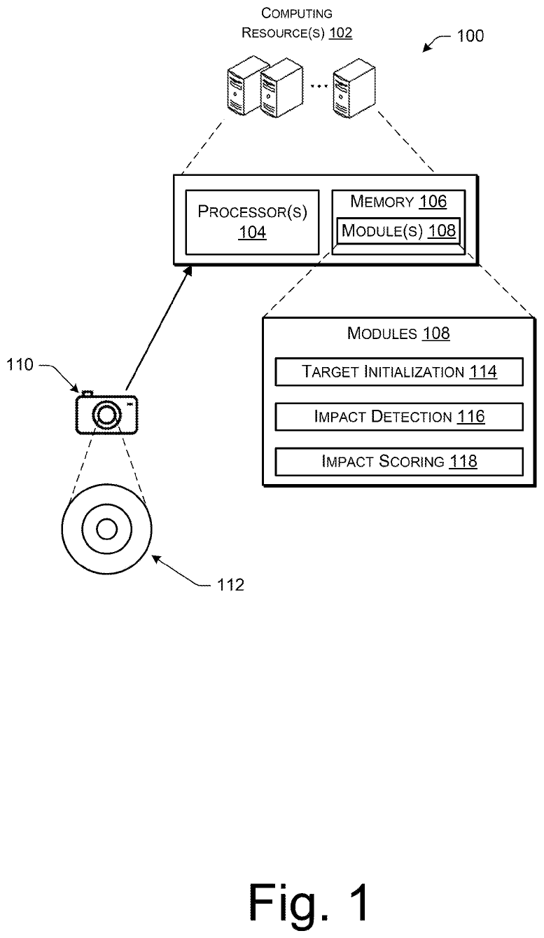

FIG. 1 illustrates a system 100 configured to automatically identify a target, classify the target, determine impacts on the target, and score the shooting string. The system 100 may include computing resources 102, which may be a mobile computing device associated with a participant at a shooting range and may include any one or more of a number of mobile computing devices, such as, for example, a smart phone, a tablet computer, a lap top computer, or other suitable computing device. The computing device 102 typically includes one or more processors 104 and memory 106 that store one or more modules 108. The modules 108 may store instructions that, when executed, cause the one or more processors 104 to perform various acts. The computing resources 102 may further include data storage, which may be remote storage, such as a remote server or a cloud-based storage system, or local storage, or a combination. The data storage may store data on previous engagements (DOPE) which can allow for data tracking over time as well as comparative data between different shooters, different firearms, different ammunition, different targets, different environments, and the like.

The storage system may further allow historical trend analysis, which can be used to show shooter performance over time, including tracking improvements. The data storage may also be analyzed to provide performance predictions, rankings, social features, among other benefits.

The system may incorporate one or more imaging sensors 110, such as any suitable video camera. In some cases, the imaging sensor 110 may be associated with the computing resources 102. For instance, in some embodiments, the computing resources 102 may be a smart phone with built in camera 110.

The camera 110 may be pointed to capture images of a target 112. The target may be located at any distance from the shooter and the camera 110 may be aimed and/or zoomed to capture images of the target. In some embodiments, the camera may be coupled to a lens, such as a spotting scope or camera lens to allow the camera to get a closer view of the target through optical or digital zooming.

The computing resources 102 may include instructions (e.g., modules 108) that allow the computing device to initialize a target 114, detect impacts on the target 116, and score the impacts on the target 118, among other things. In some embodiments, the step of identifying a target are optional, as in some cases, the system is configured to detect the scoring rings and may not perform the additional step of identifying or classifying the target.

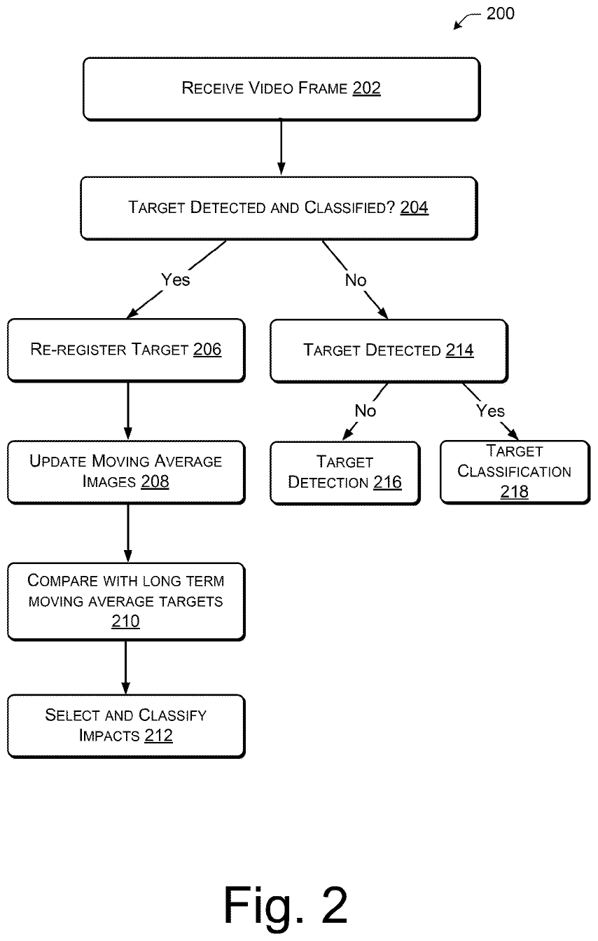

FIG. 2 illustrates a decision tree 200 configured to detect, identify, and classify a target. According to some embodiments, the system is not made aware of the type of target before the system begins looking for a target. For example, in some prior systems, a scoring system may be preprogrammed with the target that the shooter will be aiming at. This makes it easy for the system to understand the size and shape of the target, and the location and boundaries of each scoring ring or region. In the illustrated embodiments, the system is configured to automatically determine, without a priori data regarding the type of target, and determine the scoring rings and regions. For example, the system may have one or more video capture devices, which may be integrated into one or more mobile computing devices. As used herein, a mobile computing device may be one or more of a mobile phone, a smart phone, a tablet, a laptop, a personal digital assistant, smart glasses, a body cam, a wearable computing device, or some other computing device that a user may carry to a shooting range.

The mobile device may actuate a camera and capture one or more frames of a target 202. The computing device may have instructions that analyzes the one or more frames by using any suitable image analysis algorithms, to identify a target in the one or more frames. If the target is detected and classified at block 204, the target is registered with the system 206 and the scoring rings and regions are determined. The system may capture additional image frames that contain the target and look for differences from one frame to the next that may correlate with impacts on the target. The frames may be compared and at block 208, moving averages may be generated. Moving averages are a fundamental mathematical and statistical technique applied in image analysis and machine learning for various purposes, including noise reduction, feature extraction, and trend analysis. They involve the calculation of the average value of pixel intensities or other data points within a moving window or kernel across an image or dataset. Moving averages can be used to extract meaningful features from images. For example, by sliding a small window across an image and calculating the average pixel values within that window, important information can be highlighted. For example, in edge detection, the moving average can emphasize areas with abrupt changes in pixel intensity, helping to identify edges or boundaries of the target and the scoring regions. Edge detection can also be used to identify impacts on the target.

In some examples, moving averages are used for time-series data analysis. As an example, for detecting anomalies, moving averages can be used to establish a baseline behavior for a system. Any data points that deviate significantly from this baseline may be flagged as anomalies or outliers. These anomalies may be further analyzed to determine impacts on the target.

As sequential moving averages are generated, they may be combined as long-term moving averages. At block 210, the moving average images may be compared with the long-term moving averages to determine differences from one frame to a subsequent frame that indicate a change to the target, which is most likely associated with an impact on the target.

At block 212, the impacts are selected and classified. For example, the system determines the boundaries of the scoring ring and determines the location of each impact and associates the location of each impact with a score for the impact.

Returning to block 204, where the target has not been previously detected and classified, such as where a shooter is initializing the system, or has replaced the target, the system, at block 214 determines whether the target has been detected. If not, then at block 216, the system proceeds to detect the target. If the target has been detected, the system, at block 218 classifies the target, such as by identifying the boundaries of the target, the boundaries of the scoring rings, and the value of the scoring rings.

Where the system has not detected the target, it may capture one or more additional image frames and analyze the one or more additional image frames to determine that a target is located within the field of view of the imaging device. Once a target is detected, the system can then classify the target to determine its size, and the relative position and size of the scoring rings or regions.

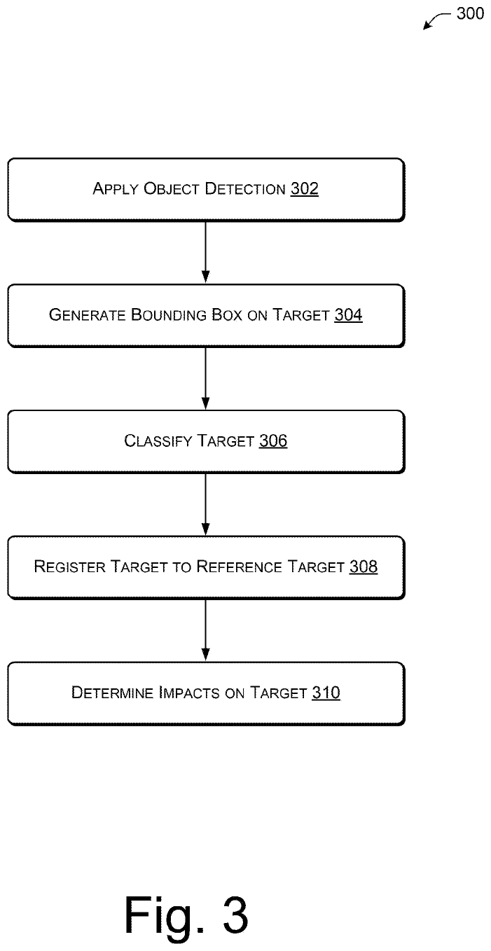

FIG. 3 further describes the initial steps that the system may take to identify and classify a target 300 by analyzing one or more image frames. Object detection is a computer vision technique that involves identifying and locating multiple objects within an image or video stream. Unlike image classification, which determines the presence of a single object class in an entire image, object detection provides a more granular understanding by not only recognizing objects but also specifying their positions through bounding boxes. In some embodiments, object detection algorithms typically output bounding boxes that enclose the detected objects. These bounding boxes consist of coordinates (x, y) for the object's top-left corner and dimensions (width and height) defining the object's spatial extent within the image.

At block 302, the system applies object detection to one or more images of the target and searches for the target. In some embodiments, the object detection model is generic with respect to targets, which allows the system to detect any target, regardless of size or shape. At block 304, where a target is found in the same location in subsequent images (e.g., 2 or more images, 3 or more images, 4 or more images, etc.) the system assumes it has located the target and defines the bounding box around the target. In some cases, finding the target in the same location in subsequent images comprises determining a moving average of the images to determine the target location, size, and shape.

At block 306, the target is optionally classified. In addition to locating objects, the system may be configured to detect objects, classify each detected object into predefined classes or categories. This allows the system to distinguish between different object types, such as circular targets, ovoid targets, rectangular targets, silhouette targets, or otherwise.

A target classifier may be applied to the image within the bounding box. The system thus determines which reference target image to apply.

At block 308, the system registers the target to the reference target image. In some cases, this involves applying a contrast adjustment to the image. This may also involve iteratively modifying the initial bounding box, such as by adjusting its corners, then projecting the adjusted bounding box onto the reference target image. The difference between the two may be applied as a score, and a hill-climbing technique may be applied to find the optimum corners, which can be correlated to be the initial location of the image. A hill-climbing technique is an optimization algorithm used to find the local maximum (or minimum) of a given objective function. By iteratively making small steps in the direction that leads to a higher value, the algorithm determines the highest value, lowest value, and thus can be used to determine the boundaries of the target and/or the boundaries of the scoring zones of the target. In some cases, object detection is combined with semantic segmentation to provide pixel-level object masks. This allows for a more precise understanding of object boundaries within an image, such as the target boundaries and the scoring ring boundaries.

At block 310, the system has initialized and registered the target and begins looking for impacts across subsequent moving averages.

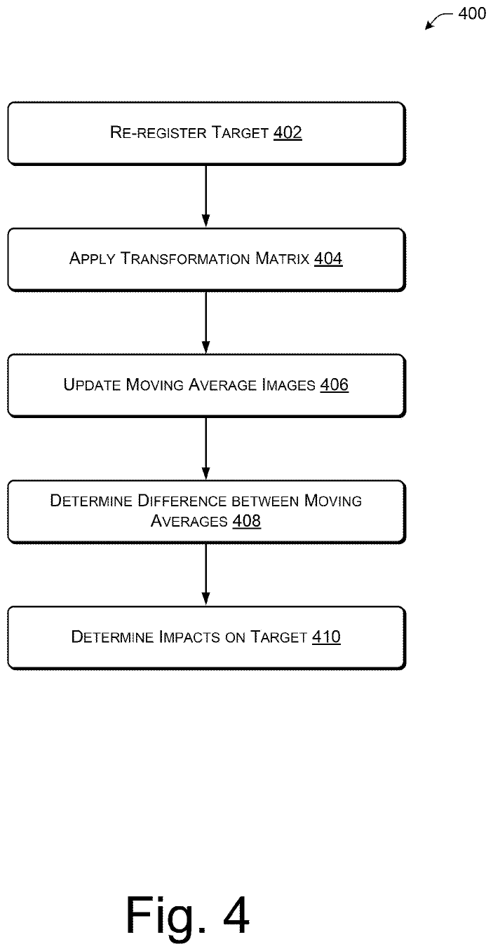

FIG. 4 describes the process 400 of registering the target 300 and determining impacts on the target. At block 402, the target may be reregistered, such as by performing a hill-climbing technique to search for new set of best corners for the target. In some cases, the hill-climbing search uses a mean-squared distance in perceptual space technique. For example, mean-squared distance, also called mean-squared perceptual error, is a metric used to measure the similarity or dissimilarity between two data points involve perceptual data, such as target corners. In some cases, for each data point, relevant perceptual features are extracted—in this case, target corners, edges, scoring rings, etc. The features can be visual descriptors which can be represented as a vector of perceptual features. These feature vectors capture the relevant information for each data point in a reduce and more informative form.

The mean-squared distance between two points (represented as their respective feature vectors) is generated by determining the squared differences between corresponding features and calculating the mean of these squared differences. The resulting mean-squared distance provides a quantitative measure of dissimilarity between the two data points in perceptual space.

At block 404, the system may apply a transformation matrix, which can be used to map the set of corners to an image. In some cases, the image upon which the coordinates are mapped has a dimension of 160 pixels, and in some cases is less than 160 pixels.

At block 406, the moving average images are updated, and in some cases, long-term moving averages are those of about 10 seconds or longer, while short-term moving averages are those of about 0.1 second. In some cases, a video camera may capture upward of 30 frames per second. For the short-term moving averages, this equates to averaging about 3 frames to determine the short-term moving average.

At block 408, the system determines the difference between moving averages. For example, the long-term moving average will be associated with a static target that hasn't changed over 10 seconds or so, and it can be compared with the short-term moving average which reflects a change in the image. Therefore, the difference between the short-term moving average and the long-term moving average will highlight changes to the image, such as an impact on the target. The system may convolve any difference images with a simple impact kernel, which in some cases may be a 5×5 uniform weight, square kernel, and look for the maximal block-wise locations in the difference image. The kernel typically refers to a convolutional filter that can be used to process and modify pixel values, such as for feature extraction. The square kernel may convolve (or move) across the image and at each position, the kernel's values can be multiplied with the pixel values in the corresponding neighborhood and the results can be summed to produce a new pixel value in the output image. Of course, the size of the kernel may be altered to adjust the extent of the neighborhood considered during convolution and may include any of a hole set of aperture kernels, having non-uniform weights, and may have any suitable size.

The convolution will return a set of potential impacts on the target. The set of potential impacts may be further filtered, such as by using simple stats on a window surrounding the flagged difference. In some cases, the window is selected to be a 16×16 window with the difference in the middle of the window. Of course, other window sizes are entirely plausible, and the pixel values described herein are only illustrative of some embodiments. The system may also apply some business rules to the windowed difference, such as, for example, the system should not detect multiple impacts in exactly the same location.

At block 410, the impacts on the target are determined. In some cases, this is accomplished by passing the filtered set of differences to an impact classifier for scoring. If the score of the difference is above a threshold value, the location is marked as an impact and another window may be placed around the impact. In some case a 10×10 window is placed around the impact location in the long-term average with the short-term average for between 5-10 following frames. This ensures that the same impact is not detected again. Accordingly, the difference is windowed by a first window, and if the difference exceeds a threshold score, the difference is windowed by a second window smaller than the first window. The windowed difference associated with the short-term moving average may be added to the long-term moving average for at least 5 frames, or at least 6 frames, or at least 10 frames, or at least 12 frames, or at least 15 frames or more. In some cases, where the score of the difference is below a threshold, the difference is marked as a false impact and the system won't need to evaluate and classify it over again.

According to some embodiments, the system may receive audio data associated with a shot being fired and determine that a shot has been fired based on the audio data. In some cases, the audio data is correlated with the target images and the system can convolve the difference target image in response to the audio data indicating that a shot has been fired. In some cases, the system may not need to continuously convolve the difference images. In this case, the system can determine, through audio data, that a shot has been fired and then update the shot-term moving average and convolve the difference images to look for a shot. In some cases, the system is configured to discriminate shots fired by the user aiming at the target against other shooters at the shooting range. In this way, the system can know when the shooter of interest fires a shot even where other active shooters are present at the range.

In some cases, the audio data may be used in the impact detection, such as by correlating the audio of a shot fired with an impact appearing on the target images.

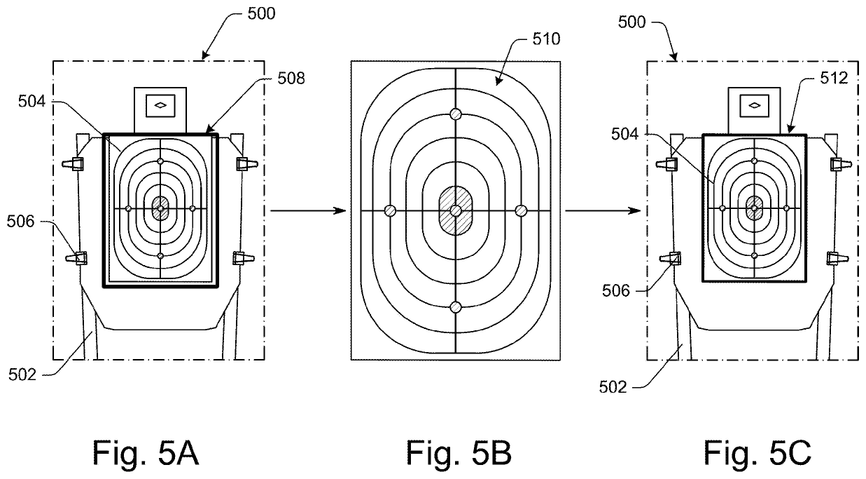

FIGS. 5A-5C illustrate and describes initializing the scoring system by identifying and classifying a target. In some cases, the system can automatically determine the boundaries of the target, while in some embodiments, user input may define the boundaries of a target. For example, using a human to computer interface (e.g., touch screen, mouse, stylus, touch pad, or the like), a human may draw a boundary around the target to aid the system in identifying the target. However, in many embodiments, the system uses machine vision to identify the target and its boundaries. FIG. 5A illustrates an image 500 captured by a camera associated with the system. The image may include a target stand 502, a target 504, target securing clips 506, and other features within the field of view. The system may determine an initial bounding box 508 around the identified target, such as by a trained target detection model. In some embodiments, a user may define the initial bounding box, such as by drawing on the computer display with a human to computer interface. The human to computer interface may be any suitable interface and in some cases is a touch screen, a pen, a mouse, a trackball, or the like. The initial bounding box may not accurately conform to the edges and corners of the target, especially in those cases where the bounding box is defined by the user. The initial bounding box and target image may be referred to as an initialization frame. The initialization frame may be converted to a Lab color space, which includes the components lightness, green to red axis, and blue to yellow axis to generate perceptual uniformity. In some cases, the luminance channel is equalized via contrast limited adaptive histogram equalization (CLAHE).

FIG. 5B illustrates a target in which the coordinates for the target are determined, as described above, and the coordinates in many cases imply a quadrilateral, which can be projected onto a reference target image 510. The reference target image 510 may also be converted to Lab color space and the squared difference (in Lab space) may be generated between the projection and the target. A hill-climbing algorithm may be applied on the coordinates, where possible deltas are small changes to the coordinates and better solutions may be determined by the squared perceptual difference.

FIG. 5C illustrates the best coordinates that have been determined, such as by the minimum difference over several random restarts of the hill-climbing algorithm. The coordinates may then be used to apply the updated bounding box 512. Therefore, even where the target image is skewed, such as the viewing angle from the camera appear to show the target as a parallelogram rather than a rectangle, the initial bounding box can be modified to conform with the shape of the target as presented in the image captured by the camera.

In some embodiments, the system may define the edges of the target through image analysis; however, in some cases, the edges of the target are irrelevant, and it is only the scoring rings that are important. Therefore, in some cases, the system is configured to identify scoring rings and is not concerned with target boundaries. In addition, the system may not need to classify the target, but rather, only need identify scoring rings. For example, the system may determine, through one or more machine learning models, that the target represents a center bulls-eye target with sequential scoring rings. The system may assign score values with each ring, such as ten points for the bullseye, nine points for the next larger ring, and so on. Similarly, the system may identify a target with five bullseye sized circles spaced throughout the target and assign a value of ten points to each of these scoring rings. One or more of the multiple bulls-eye sized rings may have radially space larger scoring rings that may be assigned lesser values than the bulls-eye sized ring. Thus, the system may omit a step of classifying a target, and just focus on the size and location of the scoring rings.

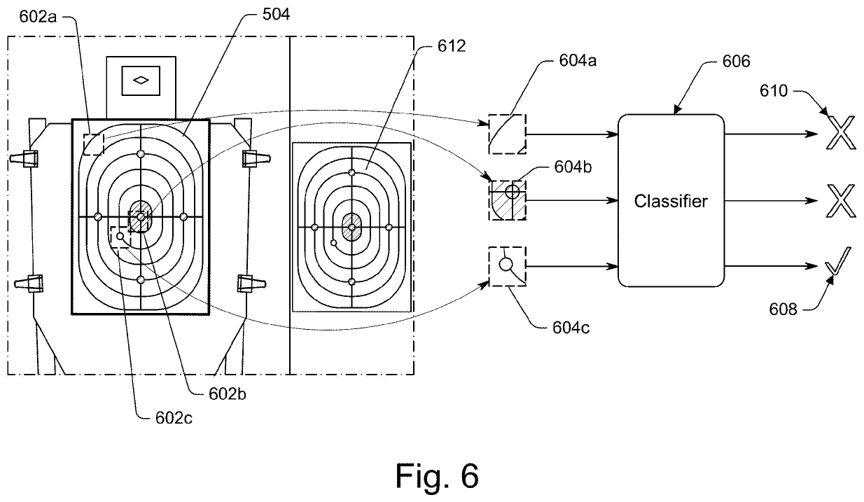

FIG. 6 illustrates and describes impact detection and scoring of the detected impacts. A machine learning model may be executed to determine if the differences between image frames are likely to be projectile impacts on the target 504. The target 504 may be reregistered, such as by applying a hill-climbing techniques with possible corner coordinates as in the target initialization step. By comparing the short-term moving average difference with the long-term moving average, differences are windowed 602a, 602b, 602c, and the difference image 612 between the current target and the long-term target average is generated.

The difference image may be convolved with an impact kernel (e.g., a windowed kernel that scans for image differences). Any point that is several standard deviations over the long-term exponential moving average (EMA) of the maximum convolution value is flagged as a possible impact 604a, 604b, 604c.

The possible impacts, 604a-604c, are fed into a machine learning model (e.g., classifier) 606 that determines if the differences are likely to be actual impacts. If the differences are above a threshold value, the system marks the differences as actual impacts 608. However, where the differences are below a threshold value, the system marks the differences as false impacts 610.

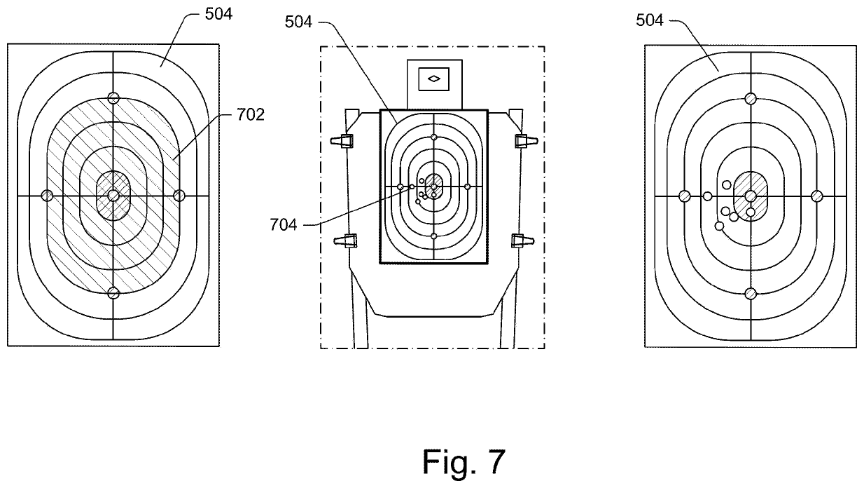

FIG. 7 illustrates and describes impact scoring on a target 504. Different scoring zones may be determined by the system based on computer vision, by references a registered target from a previous shooting session, by retrieving a stored target model from a known target database, or in some other way. The scoring zones 702 on the target may be represented as the union area of one or more simple shapes (e.g., ellipses, rectangles, circles, triangles, etc.) The coordinates of the detected impact 704 may be normalized and converted to the axes implied by the reference image. In other words, the impacts may be overlaid on the reference image, and the reference image can be used for coordinates of the impact. The coordinates may be cartesian coordinates expressed in x, y values. In some cases, the coordinates may be radial coordinates that express the impact as an angle and distance, such as from the center of the target, such as by expressing the coordinates in (r, ⊖) coordinate space. The system can then determine whether the impact is wholly within a single scoring zone or intrudes on a scoring zone boundary, which allows the system to accurately score the impact. The system may use simple geometry to determine whether any significant part of the given impact is within any of the simple shapes for each target zone.

In some embodiments, the system uses the coordinates for the impacts in further analyses. For example, by generating and storing coordinates for a given shooting string, the grouping can be quantified, which can be used as a measure of improvement over time. Similarly, a shooter's moment of angle (MOA), which is a measure of a group size in inches and minutes of an angle and from center to center and edge to edge can be determined. A grouping may further be used to define pose, grip, or motion errors during the shooting string. The grouping may be quantified, including size of group, rotation of group, or other metric.

The scoring can be quantified in any suitable metric. In some cases, the scoring is point based, in which each zone of the target receives a number of points that are added or subtracted from an initial amount. In some cases, missing shots or extra shots fired are scored as negative values or higher values depending on the type of scoring. In some cases, timed scoring is used, in which the total time is reflected in the score, and misses may be penalized by an increase in the time. In some cases, group size is used to determine scoring, and extra shots or missed shots may penalize the group size. Of course, other metrics and combinations of metrics may be determined by the system for scoring a particular shooting string.

The system may be configured to return, for each shot in a shooting string, a coordinate of the impact with the time in which the shot happened in a way that number of metrics combining the location and time can be used to range the shooting string. For instance, the time between shots may be measured, or the shot after a buzzer or other start signal can be tracked and stored with an accuracy metric.

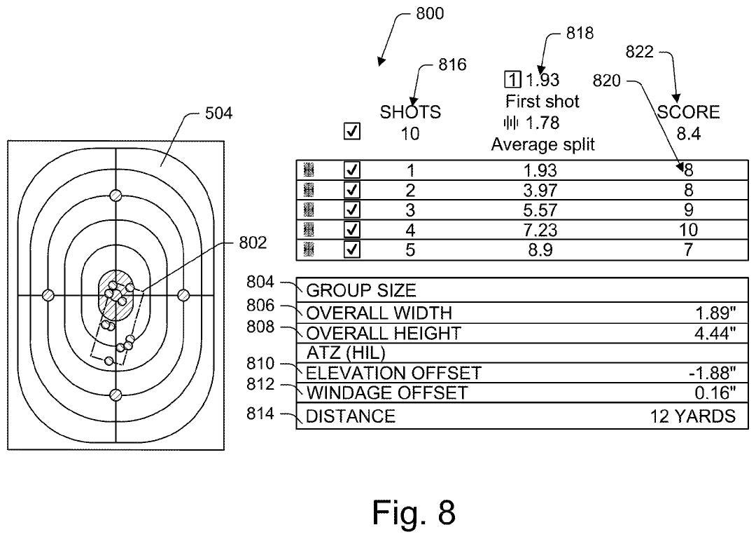

In some cases, as the impacts are identified, the system may draw a bounding box surrounding one or more of the impacts. When a shooting string is finished, the system may draw a bounding box that contains each of the shots within the group and determines a metric based on the bounding box to determine a score. As shown in FIG. 8, which illustrates a user interface 800 of a system that has been developed and is operational according to some of the embodiments described herein, the system can be configured to determine a bounding box 802, which may pass through the center of the outermost impacts, or along an edge of the impacts. The system may determine any of a number of metrics, such as, without limitation, a group size 804, an overall group width 806, a group height 808, bounding box rotation angle, MOA, elevation offset 810, windage offset 812, and may further determine the shooting distance 814, which may either be manually input or determined based on detected flight time of the projectile.

For example, the system may be configured to register the sounds of the gunfire, the shockwave of the projectile or powder deflagration, motion of the firearm or shooter, or some other indicator that a shot has been fired. The system may then detect when an impact on target happens and determine the flight time of the ammunition and based on the firearm, the ammunition, and/or the powder loading, determine a target distance. This process can be done in near real time by a simple consumer grade mobile computing device. In some cases, the mobile computing device may utilize a zoom feature of a built-in image capture device. In some cases, an external zooming lens may be used to acquire image frames by the mobile computing device. For example, a mobile phone may be coupled to a spotting scope, which provides an optical zoom through the spotting scope to allow the mobile computing device to capture clearer images of a target that may be down range. Some mobile computing devices may rely on digital zoom to capture one or more images of a target positioned down range.

The system may further determine and display the number of shots fired 816 in the current shooting string, an average split time 818 for each shot, which may be helpful for timed shooting events. The system may further show a score associated with each shot 820 and a cumulative score 822 of the shooting string.

The system may include one or more processors and one or more non-transitory computer readable media that may store various modules, applications, programs, or other data. The computer-readable media may include instructions that, when executed by the one or more processors, cause the processors to perform the operations described herein for the system.

In some implementations, the processor(s) may include a central processing unit (CPU), a graphical processing unit (GPU), both CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) may possess its own local memory, which also may store program modules, program data, and/or one or more operating systems. The one or more control systems, computer controller and remote control, may include one or more cores.

Embodiments may be provided as a computer program product including a non-transitory machine-readable storage medium having stored thereon instructions (in compressed or uncompressed form) that may be used to program a computer (or other electronic device) to perform processes or methods described herein. The computer-readable media may include volatile and/or nonvolatile memory, removable and non-removable media implemented in any method or technology for storage of information, such as computer-readable instructions, data structures, program modules, or other data. The machine-readable storage medium may include, but is not limited to, hard drives, floppy diskettes, optical disks, CD-ROMs, DVDs, read-only memories (ROMs), random access memories (RAMs), EPROMS, EEPROMs, flash memory, magnetic or optical cards, solid-state memory devices, or other types of media/machine-readable medium suitable for storing electronic instructions. Further, embodiments may also be provided as a computer program product including a transitory machine-readable signal (in compressed or uncompressed form). Examples of machine-readable signals, whether modulated using a carrier or not, include, but are not limited to, signals that a computer system or machine hosting or running a computer program can be configured to access, including signals downloaded through the Internet or other networks.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The disclosure sets forth example embodiments and, as such, is not intended to limit the scope of embodiments of the disclosure and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments, but should be defined only in accordance with the following claims and their equivalents.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

Unless otherwise noted, the terms “connected to” and “coupled to” (and their derivatives), as used in the specification, are to be construed as permitting both direct and indirect (i.e., via other elements or components) connection. In addition, the terms “a” or “an,” as used in the specification, are to be construed as meaning “at least one of.” Finally, for ease of use, the terms “including” and “having” (and their derivatives), as used in the description do not preclude additional components and are to be construed as open ended.

The specification and annexed drawings disclose examples of systems, apparatus, devices, and techniques that may provide a system and method for determining acoustical signatures of discharged firearms. It is, of course, not possible to describe every conceivable combination of elements and/or methods for purposes of describing the various features of the disclosure, but those of ordinary skill in the art recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein. Examples put forward in the specification and annexed drawings should be considered, in all respects, as illustrative and not restrictive. Although specific terms are employed herein, they are used in a generic and descriptive sense only, and not used for purposes of limitation.

Those skilled in the art will appreciate that, in some implementations, the functionality provided by the processes and systems discussed above may be provided in alternative ways, such as being split among more software programs or routines or consolidated into fewer programs or routines. Similarly, in some implementations, illustrated processes and systems may provide more or less functionality than is described, such as when other illustrated processes instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other implementations the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some implementations, illustrated data structures may store more or less information than is described, such as when other illustrated data structures instead lack or include such information respectively, or when the amount or types of information that is stored is altered. The various methods and systems as illustrated in the figures and described herein represent example implementations. The methods and systems may be implemented in software, hardware, or a combination thereof in other implementations. Similarly, the order of any method may be changed, and various elements may be added, reordered, combined, omitted, modified, etc., in other implementations.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

What I claim is:

1. A method for automatically scoring a shooting target, comprising:
receiving one or more images of a target;
generating a bounding box around the target;
classifying the target;
determining scoring rings of the target;
receiving one or more additional images of the target;
determining a difference between a short-term moving average and a long-term moving average based on received images of the target;
filtering the difference between the short-term moving average and the long-term moving average to determine an impact; and
executing an impact classifier that receives the difference and outputs a score of the impact.

2. The method of claim 1, wherein the receiving the one or more images is performed by a video capture device associated with a mobile computing device.

3. The method of claim 1, wherein the method is performed on a smart phone.

4. The method of claim 1, wherein determining a difference between a short-term moving average and a long-term moving average comprises convolving a difference image with an impact kernel.

5. The method of claim 4, wherein the impact kernel is a 5×5, uniform weight, square kernel.

6. The method of claim 1, wherein the impact classifier is configured to replace a window around a potential impact in the long-term moving average image with the short-term moving average that includes the potential impact.

7. The method of claim 6, further comprising replacing the window around a potential impact in the long-term moving average image with the short-term moving average that includes the potential impact for at least 5 subsequent frames.

8. The method of claim 6, wherein the window is at least a 10×10 pixel window.

9. The method of claim 1, wherein generating a bounding box around the target comprises iteratively modifying one or more corners of the bounding box to generate a modified bounding box and projecting the modified bounding box onto a reference target image.

10. The method of claim 9, further comprising determining corners of the modified bounding box by a hill-climbing technique.

11. The method of claim 1, further comprising determining coordinates of the impact and determining that the coordinates of the impact are within a scoring ring.

12. A system for automatically scoring a target, comprising:
a computing device having one or more processors, the one or more processors configured with instructions, the instructions comprising:
an image analyzing module configured to receive one or more images from an imaging sensor associated with the computing device;
a target classifier configured to determine one or more boundaries of the target and determine geometric boundaries of one or more scoring regions;
an impact kernel configured to compare two or more images and determine a possible impact;
a machine learning model configured to receive data associated with the possible impact and determine a likelihood of an actual impact; and
a scoring module configured to determine a score of the impact where the likelihood of an actual impact exceeds a threshold value.

13. The system of claim 12, wherein the computing device is a smart phone.

14. The system of claim 12, wherein the target classifier is configured to apply object detection to the one or more images and determine corners of the target.

15. The system of claim 12, wherein the scoring module is configured to determine coordinates of the impact and determine that the impact is within a scoring zone of the target.

16. The system of claim 15, wherein the scoring module is configured to convolve an impact kernel across a difference image to identify the location of the impact.
